(19) United States
(12) Patent Application Publication
(10) Pub. No.: US 2008/0123592 A1
(43) Pub. Date: May 29, 2008

(54) TWO-DIMENSIONAL PILOT PATTERNS

(75) Inventor: Branislav POPOVIC, Solna (SE)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/957,617

(22) Filed: Dec. 17, 2007

Related U.S. Application Data
(63) Continuation of application No. PCT/CN2005/000859, filed on Jun. 15, 2005.

(51) Int. Cl. H04Q 7/00; H04L 27/28

(52) U.S. Cl. 370/330; 375/260

(57) ABSTRACT

The present invention relates to a method for generating, in a multiple access communication system, two-dimensional pilot signal patterns for propagation channel estimation in time and frequency, with equidistant sampling. The method includes the steps of: generating a generic pilot pattern that covers completely a first dimension and covers partially a second dimension, within a segment of the second dimension where the propagation channel is considered to have a constant value, and performing periodical duplication of the generic pilot pattern along the second dimension, where the duplication interval of the generic pilot pattern is equal to the required sampling interval in the second dimension. The invention also relates to a transmitter and a receiver of a multiple access communication system, such as a multiple access communication system and a radio multiple access communication system.

### FIELD OF THE INVENTION

The present invention relates to communications systems with multiple (sub-) carriers. More exactly it concerns a method according to the preamble of claim 1. Further, it concerns a transmitter, a receiver, a multiple access communication system and a radio multiple access communication system according to claims 10, 11, 12, 13, respectively.

### BACKGROUND OF THE INVENTION

Multiple access communications systems are distinguished by the capability of efficient sharing of the limited bandwidth between the multiple users. The mutual interference between the signals of multiple users can be controlled or completely eliminated by different mechanisms, such as time-division multiple access (TDMA), frequency-division multiple access (FDMA), orthogonal frequency-division multiple access (OFDMA), code-division multiple access (CDMA) and multi-carrier CDMA (MC-CDMA).

Besides the data signals, there are a number of other signals transmitted from each user that serve to support the correct reception of data signals. One example of such supporting transmitted signals are pilot signals for channel estimation in the receiver. Such signals are predetermined tones placed in different locations in frequency and time of the communication channel, forming specific patterns. In the cellular systems, such pilot patterns for channel estimation can be transmitted both on the downlink (DL) and the uplink (UL).

In FDMA, OFDMA or MC-CDMA systems the pilot patterns are used in the receivers to obtain samples or the transmission channel both in time and frequency dimensions. These pilot patterns have to allow equidistant sampling of the signals in said both dimensions, in order to estimate a given transmission channel in the most efficient way, i.e. in order to alleviate interpolation or filtering of the channel samples.

In a broadcast system, such as Digital Video Broadcasting (DVB), one pilot pattern is enough for the whole system. However, for instance in cellular systems with OFDM or, in general, multi-carrier transmission, each of the base stations needs to transmit on the downlink a two-dimensional pilot pattern for the channel estimation in a user equipment (UE). If all the transmitted pilot patterns are the same, they will interfere in the UE, especially if the UE is close to the cell edge. As pilot signals in general have higher power than data signals, this interference becomes particularly critical. Thus it is desirable to have a set of different pilot patterns such that each pair of pilot patterns has a small maximum number of hits (“hit” is the transmission on the same frequency both from the serving and non-serving cells during an observed OFDM symbol interval at the UE). The different pilot patterns from the set can be allocated to the neighbouring base stations.

There have been several efforts to design pilot patterns for multiple access communication systems, trying to optimise various parameters.

EP 1 148 673 A2 describes pilot pattern designs on the basis of Latin square sequences. Here the pilot patterns are used not just for the channel estimation, but also for the base station identification (cell search) and DL synchronisation. Each base station has a unique pilot pattern. Each pilot pattern is defined over the whole available frequency spectrum, with a certain time periodicity. The different pilot patterns can collide at most once per such period. Looking at the patterns, they form lines in a time-frequency grid of the communication channel. These lines have different slopes for different patterns. The potential problem for channel estimation with this approach is that the sampling interval in frequency domain depends on the slope, so the different base stations will have different minimum sampling intervals.

In the article “Base station identification for FH-OFDMA systems”, VTC 2004 spring, 2004, this problem is avoided as the pilot tones are located periodically in frequency, so one can control the sampling interval in the frequency domain independently of the slope of the Latin square sequence and so enabling equidistant sampling of the patterns.

One problem with the prior art above is that when a certain portion of the communication channel is bad, or when experiencing interference from a neighbouring base station, the pilots may be subject to a substantial amount of interference. This can severely degrade the performance of such a system.

Another problem with prior art pilot patterns arises when pilot patterns are used with MIMO (Multiple Input, Multiple Output)-systems, which are systems that use multiple transmit and receive antennas. For such systems, each transmit antenna must be assigned with an orthogonal pilot pattern for the estimation of the particular transmission channel for that particular antenna. Also, different MIMO-systems should simultaneously use different pilot patterns with limited interference, making the need for more pilot patterns ever greater. Because the amount of patterns available according to prior art is limited, they soon could get exhausted when used with MIMO.

A further problem with the prior art is that pilot patterns are defined over the whole frequency spectrum. This sets a constraint on the possibility to flexibly plan the use of resources. There is a need for a method that could allocate pilots to predetermined parts of the T-F-grid that would be allowed for the use for pilots. In this way it would be possible to easily separate different transmission channels in the T-F-grid (signalling, data, pilots).

Yet another problem is to make sure that pilot patterns are as orthogonal as possible, also when users are not synchronised, i.e. under arbitrary time shift.

### SUMMARY

The present invention is to propose a solution for or a reduction of one or more of the problems of the prior art. The present invention is consequently to devise a method that enables flexible planning of pilot patterns with regard to occupied area of the T-F-grid, that enables better pilot pattern performance, in terms of mitigation of hits under bad transmission channel conditions or under interference from other users, that enables generation of a multitude of patterns, that also is suitable for MIMO-systems, and finally all of this while ensuring a certain level of orthogonality between pilot patterns, i.e. ensuring a predictable maximum amount of mutual hits between patterns, both under synchronous and asynchronous operation.

According to the invention this is accomplished by a method having the characteristics that are defined in claim 1, by a transmitter having the characteristics of claim 10, by a receiver having the characteristics of claim 11, by a communication system having the characteristics of claim 12 and by a radio communication system having the characteristics of claim 13.

According to the invention a method is devised for generating, in a multiple access communication system, two-dimensional pilot signal patterns for propagation channel estimation in time and frequency, with equidistant sampling, said patterns including tones placed in time and frequency units. The method includes:
generating a generic pilot pattern that covers completely a first dimension and covers partially a second dimension, within a segment of the second dimension where the propagation channel is considered to have a constant value;
performing periodical duplication of the generic pilot pattern along the second dimension, where the duplication interval of the generic pilot pattern is equal to the required sampling interval in the second dimension. The first and second dimension could according to the invention be time and frequency, respectively, or vice versa.

The method of the invention could be implemented in a transmitter for a multiple access communication system. Preferably, such a transmitter would be communicating with a corresponding receiver for a multiple access communication system including means for receiving and processing signals generated by the transmitter. Together they would form part of a multiple access communication system that would include at least one such transmitter and at least one such receiver.

According to the invention, in a radio multiple access communication system with a number of transmit antennas, various subsets of orthogonal pilot patterns according to the method of the invention could be allocated to different users, so that each orthogonal pattern is used for the transmission from a particular transmit antenna.

Additional features and advantages of the present invention will be apparent from the following description.

### BRIEF DESCRIPTION OF THE DRAWINGS

Embodiments exemplifying the invention will now be described, by means of the appended drawings, on which

FIG. 1 illustrates a time-frequency grid with a pilot pattern,

FIG. 2 illustrates another time-frequency grid including three different pilot patterns,

FIG. 3 illustrates a multiple access communication system, and

FIG. 4 illustrates a radio multiple access communication system with a number of antennas.

### DETAILED DESCRIPTION OF PREFERRED EMBODIMENTS

To familiarise the concept of pilot patterns, FIG. 1 shows a T-F grid (time-frequency grid) including frequency and time axes, forming a communication channel. In this grid, an exemplary pilot pattern, for channel estimation, is depicted. The pilot pattern includes tones that are modulated on to certain carriers at certain time instances, these time/frequency slots with pilots are illustrated with black squares in the grid. In this example the pilot pattern can be said to have a slope in the grid.

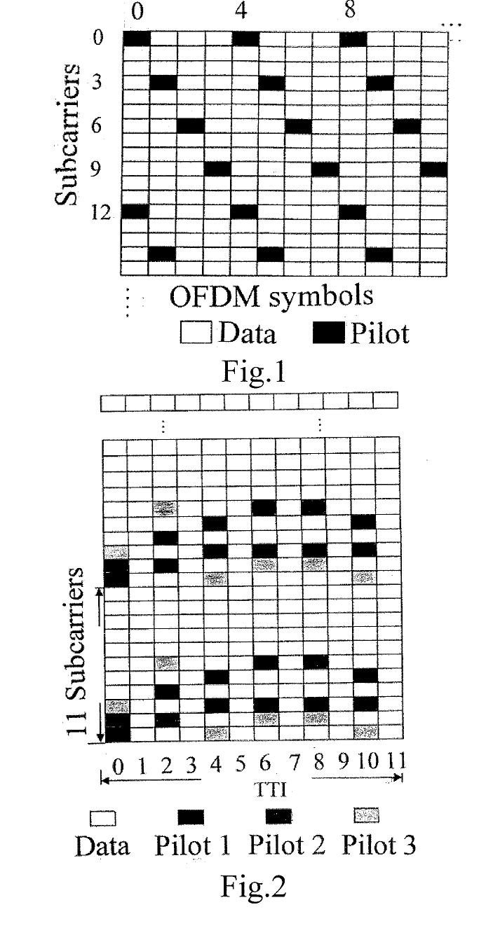

According to the invention, a general design method for two-dimensional pilot patterns for channel estimation is specified on the basis of the repetition of a generic pilot pattern in one of the two dimensions. A generic pilot pattern covers completely one dimension and covers partially the second dimension, within a segment of the second dimension where the propagation channel is considered to have a constant value. This can be seen from FIG. 2, which shows three different pilots 1, 2 and 3 that occupy completely the dimension of the x-axis, in this case the x-axis dimension is time. As can be seen in the depicted particular case, the pilots only occupy the first six carriers of each segment. Therefore, we have explicitly allowed that the alphabet size of the generic pattern can be smaller than the sampling interval in the second dimension, because if the channel is constant over each segment in the second dimension, then pilot tones do not necessarily need to be placed at each and every position in the time-frequency grid of the mentioned segment. The channel estimates taken at any position within the segment will be of the same quality as from any other position within the segment. This allows a higher flexibility in the generic pilot pattern design, as well as higher flexibility in coordination between the data and pilot subcarriers. The second dimension is divided into segments; in this case each segment includes 11 subcarriers. Then, the generic pilot pattern is repeated along the second dimension, in this case frequency, where the repetition interval of the generic pilot pattern is equal to the required sampling interval in the second dimension. As can be seen from FIG. 2, the pattern of the lower part of the grid is indeed repeated 11 subcarriers above the lower part.

In this way, using a generic pattern as above and then duplicating this pattern along one dimension of the pilot pattern grid gives great flexibility in pattern generation, while preserving equidistant sampling properties of patterns.

With this method, it becomes possible to generate a large set of different pilot patterns and that yields several benefits. A first benefit is that the problem with interference, due to channel properties or due to other users, can be greatly relieved. This is because the great number of patterns will be able to “average” out disturbances. This averaging could be performed by pseudo-randomly changing pilot patterns for a particular user for consecutive transmission time intervals. At the same time, for MIMO applications the need for a multitude of patterns will be fulfilled. Another benefit is that because the generic pilot pattern will cover partially the second dimension within a segment of that dimension, and not necessarily the whole of that segment, this is a solution to the problem with resources planning, as above.

According to the invention the generic pilot pattern could be obtained from an integer sequence by separating the successive sequence elements with equal number of empty signalling units, corresponding to the required sampling interval in the first dimension, while the sequence elements determine the position of tones in the second dimension. As can be seen in FIG. 2, along the x-axis, in this case corresponding to time and the first dimension, pilots are placed every second time slot. So this is an implementation with the number of empty signalling units being one (1) corresponding to a sampling interval in the first dimension (time in this case) of two time slots. The value of the sequence corresponds to the position of the pilot, for instance in FIG. 1 the sequence of pilot 1 would be {0,1,4, . . . } corresponding to sub carriers 0, 1, 4, . . . in time slots 0, 2, 4, . . .

A general construction method for a large set of generic pilot patterns with limited cross correlation is proposed on the basis of the associative polynomials. The integer sequence used for generic pattern generation for that large set is obtained by mapping from a sequence {f(i)} of length L defined as

$$\begin{matrix}f ( i ) = P [ x ( i ) ] , i = 0 , 1 , … , L - 1 & ( 1 ) \\ P ( x ) = {\sum }_{j = 0}^{k} {n}_{j} {x}^{j} , & ( 2 )\end{matrix}$$

where P(x) is an associated polynomial of a degree k, whose argument function x(i) is a sequence of elements of a Galois Field GF(Q), where “i” is the ordinal number of the sequence element x(i), and where multiplications and additions in the polynomial P(x) are performed in GF(Q), Q is power of prime.

The set of generic pilot patterns could be obtained from the set of associated polynomials with different coefficients nⱼ. The maximum number of different patterns, then, is Q^{k+1}.

It can be easily shown by finding the difference polynomial of the two associated polynomials, that in this way the maximum number of hits between any two sequences is equal to the product of the maximum order (k) of the polynomials and the maximum number of appearances of the same element in the sequence x(i).

The generic pilot pattern could be obtained from an integer sequence by separating the successive sequence elements with equal number of empty signalling units, corresponding to the required sampling interval in the first dimension, while values of the sequence elements determine the position of tones in the second dimension. In this way a universal method of generating the generic pilot pattern is devised and equidistant sampling properties are preserved.

The integer sequence could for instance be obtained by mapping from a sequence f(i)=P[x(i)], where

$$P ( x ) = {\sum }_{j = 0}^{k} {n}_{j} {x}^{j}$$

is an associated polynomial of a degree k, whose argument function x(i) is a sequence of elements of a Galois Field GF(Q), where “i” is the ordinal number of the sequence element x(i), and where multiplications and additions in the polynomial P(x) are performed in GF(Q), Q is power of prime. A set of generic pilot patterns could be obtained from a set of associated polynomials with different coefficients. The use of an associated polynomial yields a large set of pilot patterns with limited cross correlation. So it is possible achieve a large set of pilot patterns that has a predictable level of orthogonality for any pair of pilot patterns in the set.

According to the invention, for applications where concurrent users of different pilot patterns (e.g. base stations in a cellular system) are not mutually time synchronized, three general construction methods for sets of pilot patterns are proposed on the basis of the specific argument functions x(i) and specific sets of the associated polynomials.

All three construction methods produce sets of patterns where each pair of pilot patterns has at most either k or 2k hits under arbitrary mutual non-zero periodic time shift. Proofs of the mathematical properties for these construction methods can be found in:

B. M. Popovic, “New sequences for asynchronous frequency-hopping multiplex”, IEEE Electronics Letters, Vol. 22, No. 12, pp. 640-642, Jun. 5, 1986,

R. M. Mersereau and T. S. Seay, “Multiple access frequency hopping patterns with low ambiguity”, IEEE Transactions on Aerospace and Electronics Systems, Vol. AES-17, pp. 571-578, July 1981, and

T. S. Seay, “Hopping patterns for bounded mutual interference and frequency hopping multiple access”, IEEE Military Communications Conference, MILCOM-82, Boston, Mass., pp. 22.3.1-22.3.6, 1982.

Construction 1) is defined as:

x(i)=i, i=0,1,2, . . . , Q−1, (1)

Q is a prime, nₖ₋₁ is fixed in (2), all other coefficients nj take all the values from GF(Q).

This method produce sets of Q^{k} patterns such that each pair of pilot patterns has at most k hits under arbitrary mutual non-zero periodic time shift.

Construction 2) is defined as:

x(i)=αⁱ, i=0,1,2, . . . , Q−2, (2)

α is a primitive element of GF(Q), Q is a power of prime, n₁ is fixed in (2), all other coefficients nⱼ take all the values from GF(Q).

This method produces sets of Q^{k} patterns such that each pair of pilot patterns has at most k hits under arbitrary mutual non-zero periodic time shift.

Both constructions 1) and 2) produce the same maximum number of different patterns, equal to Q^{k}. For a given maximum number of pair-wise hits, and the same number of different patterns, construction 1) is a bit better than construction 2) in terms of normalised cross correlation (k/L), because the length of resulting integer sequences is greater (Q instead of Q−1).

Construction 3) is defined as:

$$x ( i ) = \{ \begin{matrix}1 / i , & i = 1 , 2 , … , Q - 1 \\ 0 , & i = 0\end{matrix} , \qquad 3 )$$

Q is a prime, all coefficients nⱼ take all the values from GF(Q).

Construction 3) produces Q^{k+1} different patterns of length Q, with at most 2 k hits between any two patterns from the set for an arbitrary mutual non-zero cyclic time shift. Construction 3) can be modified to produce a smaller set of patterns but with reduced pair-wise interference, if the coefficient n₀ is fixed and all other coefficients nⱼ take all the values from GF(Q). In that case, there are Q^{k} different patterns of length Q, with at most 2 k−1 hits between any two patterns from the set for an arbitrary mutual non-zero cyclic time shift.

An outline of a proof for 3) would be as follows. We have to prove that the maximum number of hits between two different sequences is at most 2 k for an arbitrary non-zero cyclic time shift p. Define two associate functions A(i) and B(i) for the sequences. Define the difference function D(i)=A(i+p)−B(i). It is now sufficient to show that the maximum number of zeros of D(i) is equal to 2 k, and that D(i) can be a constant equal to zero only if the two sequences are the same.

Now consider, as an example, the generation of three pilot patterns. These are the patterns from FIG. 2. In this case, we make the assumption that the sampling interval in the frequency domain is M=11 subcarriers and in the time domain 2 OFDM symbols. We use method 1), where x(i) is given by:

x(i)=i, i=0,1,2, . . . , Q−1, (1)

and in this case with Q=7 and k=2. We shall fix the coefficient nₖ₋₁=n₁=0. We study 3 out of the total of 49 (Q^{k}=7²=49) associated polynomials: P₁(x)=x², P₂(x)=2x²+1, and P₃(x)=3x²+2. Now, as we traverse the sequence i=0,1,2, . . . ,6, each polynomial outputs a corresponding sequence. For instance for p₁ the sequence is: 0,1,4,2,2,4, . . . The last element, shown, of this sequence is 4, because 5² mod(6)=4. I.e. it was a requirement of the method to perform computations in the Galois field GF(6). Now, one can easily see how this sequence for pilot 1 maps onto the T-F-grid. Each value of the sequence corresponds to the position of the pilot tone along the frequency (sub carrier) index.

It should be noted that the patterns in FIG. 2 are orthogonal, i.e. they have no hits. Thus, these patterns form a non-trivial subset of orthogonal pilot patterns that can be used for MIMO transmission as well. (The trivial orthogonal subsets can be obtained from the subsets of the polynomials with all the coefficients the same, except the no coefficient.)

Such patterns are useful in multiple antenna transmission (MIMO) systems, where each of the orthogonal pilot patterns can be allocated for the transmissions from the different transmit antennas at the same base station (or user equipment). The other subset of orthogonal pilot patterns, but from the same set of pilot patterns with limited mutual interference, can be allocated for the MIMO transmissions from different transmit antennas at the other base stations. In that way it is ensured that even MIMO transmissions from the different asynchronous base stations would introduce limited and pre-determined mutual interference in the system.

Various argument functions, together with variations of Q and coefficients are possible, yielding various subsets of pilot patterns. Such variations include:

1) Q is a prime number and the argument function is x(i)=i, i=0,1,2, . . . , Q−1, the coefficient nₖ₋₁ is fixed and all other coefficients nⱼ take all the values from GF(Q).

2) Q is a power of prime and the argument function is x(i)=αⁱ, i=0,1,2, . . . , Q−2, αis a primitive element of GF(Q), the coefficient n₁ is fixed and all other coefficients n take all the values from GF(Q).

3) Q is a prime, the argument function is

$$x ( i ) = \{ \begin{matrix}1 / i , & i = 1 , 2 , … , Q - 1 \\ 0 , & i = 0\end{matrix} ,$$

and all the coefficients nj take all the values from GF(Q). In a further subset of this subset, the coefficient no is fixed and all other coefficients nⱼ take all the values from GF(Q).

All three subsets above yields pilot pattern sets with predictable maximum amount of hits for every pair of patterns, under arbitrary mutual non-zero periodic time shift. That is to say, with the method above we also address the problem with orthogonality of the pilot patterns, also for users that are not time synchronised.

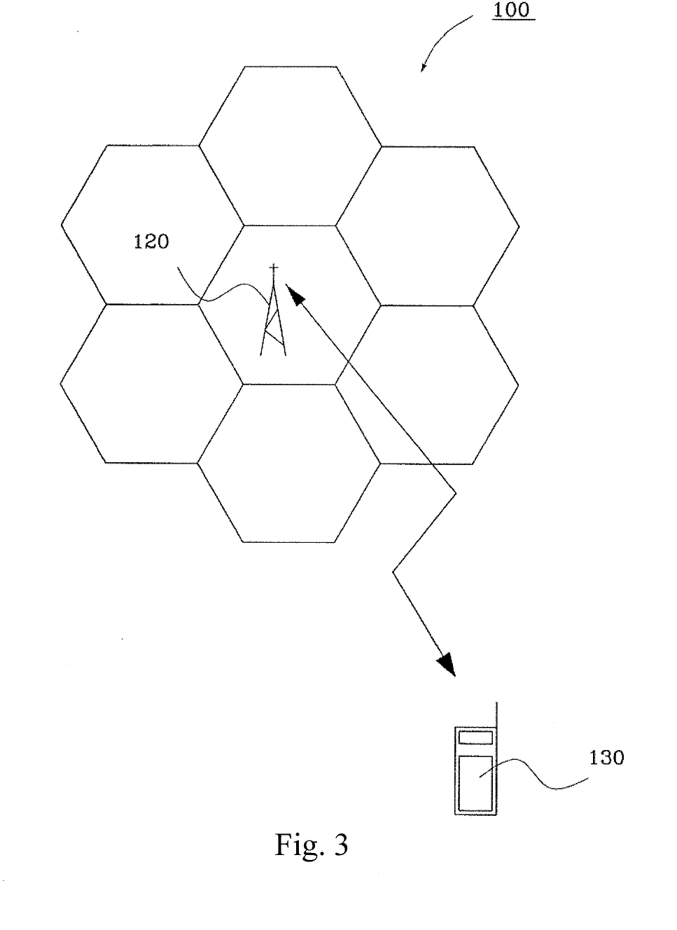

Now with reference to FIG. 3, the invention also embraces a multiple access communication system, which for instance could include base station(s) 110 of a cellular system 100 and terminal(s) 130 communicating with said base station(s). The base station(s) and/or terminal(s) would include at least one transmitter with means for executing the method according to the invention. This means could be arranged to pseudo-randomly change pilot patterns from one transmission interval to another. The base station(s) and/or terminal(s) would also include at least one receiver including means for receiving and processing signals generated by the transmitter.

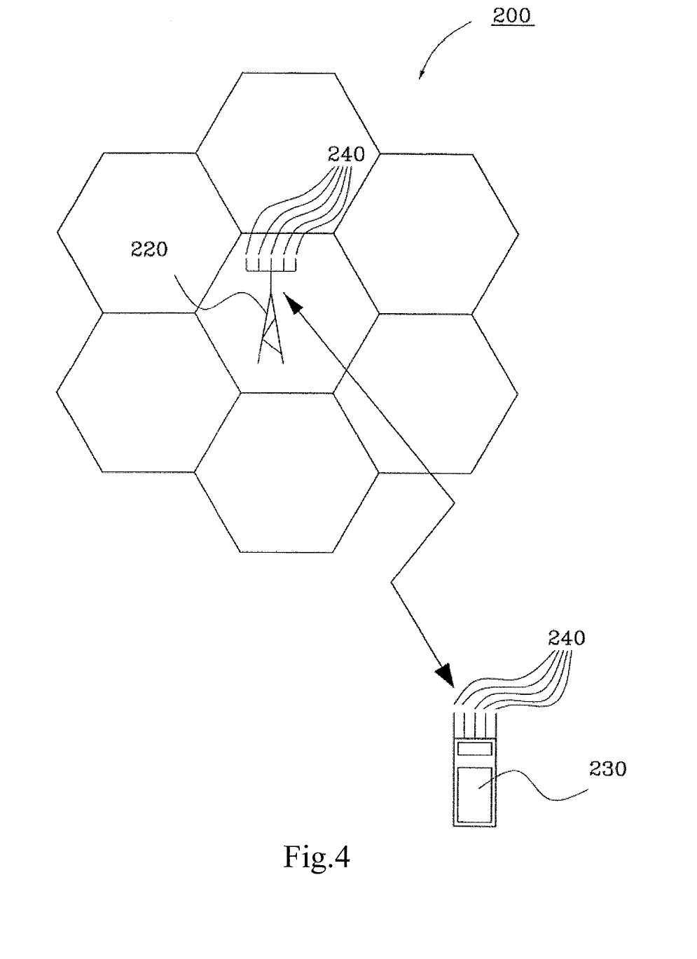

With reference to FIG. 4, the invention also embraces a radio multiple access communication system including a number of antennas, such that various subsets of orthogonal pilot patterns according to the method of the invention are allocated to different users, for instance base station(s) 210 of a cellular system 200 and terminal(s) 230 communicating with said base station(s), so that each orthogonal pattern is used for the transmission from a particular transmit antenna 240. These pilot patterns could be changed pseudo-randomly from one transmission interval to another.

It is understood that the description of the invention has been provided as explanatory only, and the invention could be varied in many ways within the scope of the attached claims.

For instance, it is possible to switch dimensions so that the first dimension of the generic pilot pattern becomes frequency and the second dimension becomes time.

1. A method for generating, in a multiple access communication system, two-dimensional pilot signal patterns for propagation channel estimation in time and frequency, with equidistant sampling, said patterns comprising tones placed in time and frequency units, the method comprising:
generating a generic pilot pattern that covers completely a first dimension and covers partially a second dimension, within a segment of the second dimension where the propagation channel is considered to have a constant value;
performing periodical duplication of the generic pilot pattern along the second dimension, where the duplication interval of the generic pilot pattern is equal to the required sampling interval in the second dimension.

2. The method according to claim 1, wherein the first dimension is time and the second dimension is frequency, or vice versa.

3. The method according to claim 1, wherein the generic pilot pattern is obtained from an integer sequence by separating the successive sequence elements with equal number of empty signalling units, corresponding to the required sampling interval in the first dimension, while the sequence elements determine the position of tones in the second dimension.

4. The method according to claim 3, wherein the integer sequence is obtained by mapping from a sequence f(i)=P[x(i)], where
$$P ( x ) = {\sum }_{j = 0}^{k} {n}_{j} {x}^{j}$$
is an associated polynomial of a degree k, whose argument function x(i) is a sequence of elements of a Galois Field GF(Q), where “i” is the ordinal number of the sequence element x(i), and where multiplications and additions in the polynomial P(x) are performed in GF(Q), Q is power of prime.

5. The method according to claim 4, wherein a set of generic pilot patterns are obtained from a set of associated polynomials with different coefficients.

6. The method according to claim 5, wherein Q is a prime, the argument function is x(i)=i, i=0,1,2, . . . , Q−1, the coefficient nₖ₋₁ is fixed and all other coefficients nj take all the values from GF(Q).

7. The method according to claim 5, wherein Q is a power of prime and the argument function is x(i)=αⁱ, i=0,1,2, . . . , Q−2, α is a primitive element of GF(Q), the coefficient n₁ is fixed and all other coefficients nⱼ take all the values from GF(Q).

8. The Method according to claim 5, wherein Q is a prime, the argument function is
$$x ( i ) = \{ \begin{matrix}1 / i , & i = 1 , 2 , … , Q - 1 \\ 0 , & i = 0\end{matrix} ,$$
and all the coefficients nj take all the values from GF(Q).

9. The Method according to claim 8, wherein the coefficient no is fixed and all other coefficients nⱼ take all the values from GF(Q).

10. A transmitter in a multiple access communication system comprising a processor configured to implement a method for generating two-dimensional pilot signal patterns for propagation channel estimation in time and frequency, with equidistant sampling, said patterns comprising tones placed in time and frequency units, wherein the method comprises:
generating a generic pilot pattern that covers completely a first dimension and covers partially a second dimension, within a segment of the second dimension, wherein the propagation channel is considered to have a constant value;
performing periodical duplication of the generic pilot pattern along the second dimension, wherein the duplication interval of the generic pilot pattern is equal to the required sampling interval in the second dimension

11. The transmitter according to claim 10 wherein the processor is arranged to pseudo-randomly change pilot patterns from one transmission interval to another.

12. A receiver for a multiple access communication system comprising a processor configured to receive and process signals generated by a transmitter in the multiple access communication system comprising a processor configured to implement a method for generating two-dimensional pilot signal patterns for propagation channel estimation in time and frequency, with equidistant sampling, said patterns comprising tones placed in time and frequency units, the method comprising:
generating a generic pilot pattern that covers completely a first dimension and covers partially a second dimension, within a segment of the second dimension, wherein the propagation channel is considered to have a constant value;
performing periodical duplication of the generic pilot pattern along the second dimension, wherein the duplication interval of the generic pilot pattern is equal to the required sampling interval in the second dimension.

13. The receiver according to claim 12, wherein the processor comprised in the transmitter is arranged to pseudo-randomly change pilot patterns from one transmission interval to another.

14. A multiple access communication system comprising:
at least one transmitter adapted to execute a method for generating two-dimensional pilot signal patterns for propagation channel estimation in time and frequency, with equidistant sampling, said patterns comprising tones placed in time and frequency units, wherein the method comprises:
generating a generic pilot pattern that covers completely a first dimension and covers partially a second dimension within a segment of the second dimension, wherein the propagation channel is considered to have a constant value;
performing periodical duplication of the generic pilot pattern along the second dimension, wherein the duplication interval of the generic pilot pattern is equal to the required sampling interval in the second dimension; and
at least one receiver adapted to receive and process signals generated by the at least one transmitter.

15. The multiple access communication system according to claim 14, wherein the transmitter is arranged to pseudo-randomly change pilot patterns from one transmission interval to another.

16. A radio multiple access communication system with a number of antennas, wherein various subsets of orthogonal pilot patterns, wherein a set of generic pilot patterns obtained from a set of associated polynomials with different coefficients are allocated to different users, so that each orthogonal pattern is used for the transmission from a particular transmit antenna (240).

17. The radio multiple access communication system according to claim 16, wherein the pilot is changed pseudo-randomly from one transmission interval to another.
